(19) United States
(12) Patent Application Publication
(10) Pub. No.: US 2026/0027711 A1
(43) Pub. Date: Jan. 29, 2026

(54) ROBOT WITH WHEELED SELF-BALANCING BASE

(71) Applicant: Maven Robotics, Inc., Santa Clara, CA (US)

(72) Inventor: Troy Alexander Carter, Sunnyvale, CA (US)

(21) Appl. No.: 19/177,408

(22) Filed: Apr. 11, 2025

Related U.S. Application Data
(60) Provisional application No. 63/676,854, filed on Jul. 29, 2024.

(51) Int. Cl. B25J 9/16; B25J 5/00; B25J 9/00; B25J 19/00; B25J 19/02

(52) U.S. Cl. CPC B25J 9/1661; B25J 5/007; B25J 9/0009; B25J 9/1682; B25J 19/0008; B25J 19/005; B25J 19/023

(57) ABSTRACT

A mobile robot includes human-like physical proportions and a wheeled self-balancing base. The base may include an omni-directional mobile platform and an articulated (e.g., two-axis) lower joint to provide dynamic self-balancing capability while also maintaining a high level of stability during failures and when unpowered. The robot may furthermore include a length-adjustable pedestal that couples between the mobile base and an upper body. The upper body may include a pair of robot arms with swappable end effectors. The mobile robot may be employed for a wide variety of robot tasks such as lifting objects, carrying objects, pushing objects, pulling objects, or manipulating objects in settings such as warehouses or factories.

### CROSS-REFERENCE TO RELATED APPLICATIONS

This application claims the benefit of U.S. Provisional Patent Application No. 63/676,854 filed on Jul. 29, 2024, which is incorporated by reference herein.

### BACKGROUND

### 1. Field of Invention

The disclosed embodiments relate generally to a robot and more specifically to a human-like robot with a wheeled self-balancing base.

### 2. Description of Related Art

Recent advances in machine learning and artificial intelligence have led to increased interest in general purpose, human-like robotic systems to perform tasks that are currently performed by humans. Current robots have significant shortcomings. For example, current walking robots are slow moving with poor stability, low battery capacity, require complex electronic and mechanical components, and are expensive. Non-humanoid robots typically have very limited applications and difficulty navigating over non-smooth surfaces.

### BRIEF DESCRIPTION OF FIGURES

Non-limiting and non-exhaustive examples are described with reference to the following figures.

FIG. 1A is a side view of a robot.

FIG. 1B is a front view of the robot.

FIG. 2A is an example view of a robot that enables tilt in pitch via an actuated base joint.

FIG. 2B is an example view of a robot that enables tile in roll via an actuated base joint.

FIG. 3A is an example view of a robot with a telescoping pedestal for torso height adjustment.

FIG. 3B is an example view of a robot with a telescoping pedestal for torso height adjustment and an arched torso.

FIG. 3C is an example view of a robot with a rail-based pedestal for torso height adjustment.

FIG. 3D is an example view of a robot with an articulated pedestal for torso height adjustment.

FIG. 4A is a first example view of a robot navigating unlevel ground.

FIG. 4B is a second example view of a robot navigating unlevel ground.

FIG. 4C is an example view of a robot employing forward tilt when accelerating.

FIG. 4D is an example view of a robot positioned to interact with objects on a raised platform.

FIG. 4E are example views of a robot with a telescoping pedestal configured at different heights.

FIG. 4F is an example view of a robot with extended reach via an actuated base joint.

FIG. 4G is an example view of a robot pushing an object with its arms.

FIG. 4H is an example view of a robot pushing an object via its mobile base.

FIG. 4I is an example view of a robot carrying an object with extended arms.

FIG. 4J is an example view of a robot carrying an object with curled arms.

FIG. 5A is a first example view of an implementation of a robot with a mobile base, an actuated base joint, and telescoping pedestal.

FIG. 5B is a second example view of an implementation of a robot with a mobile base, an actuated base joint, and telescoping pedestal.

FIG. 6 is an example view of a two-axis base joint of a mobile base of a robot and omnidirectional wheels.

FIG. 7 is an example view of a mobile base of a robot with steerable wheels.

FIG. 8 is an example view of a robot arm for a robot.

FIG. 9 is a block diagram illustrating an example electronics architecture for a robot.

FIG. 10 is a block diagram illustrating an example control scheme for a robot.

FIG. 11 is a flowchart illustrating an example process for controlling a robot.

### DETAILED DESCRIPTION

The figures and the following description describe certain embodiments by way of illustration only. One skilled in the art will readily recognize from the following description that alternative embodiments of the structures and methods may be employed without departing from the principles described.

A mobile robot includes human-like physical proportions and a wheeled self-balancing base. The base may include an omni-directional mobile platform and an articulated (e.g., two-axis) lower joint to provide dynamic self-balancing capability while also maintaining a high level of stability during failures and when unpowered. The robot may furthermore include a length-adjustable pedestal that couples between the mobile base and an upper body. The upper body may include a pair of robot arms with swappable end effectors. The mobile robot may be employed for a wide variety of robot tasks such as lifting objects, carrying objects, pushing objects, pulling objects, or manipulating objects in settings such as warehouses or factories.

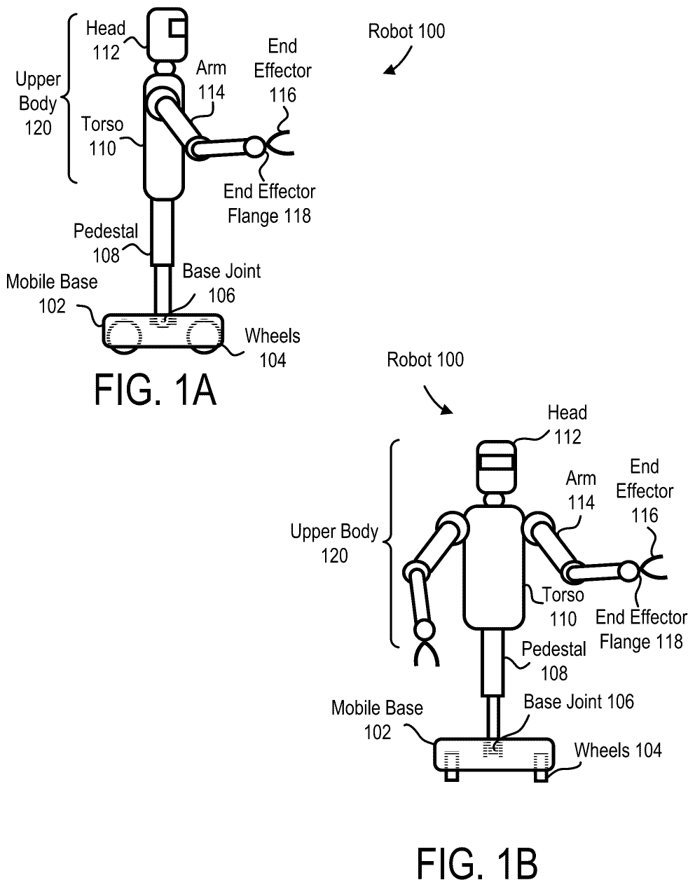

FIGS. 1A-1B illustrate a side view and a front view respectively of an example robot 100. The robot 100 includes a mobile base 102 having a set of wheels 104, a pedestal 108, a base joint 106 that couples between the pedestal 108 and the mobile base 102, and an upper body 120 supported by the pedestal 108. The upper body 120 includes a torso 110, one or more arms 114 having end effectors 116 coupled to the arms 114 via end effector flanges 118, and a head 112. Alternative embodiments of the robot 100 may include fewer elements, additional elements, or different elements than those shown. For example, some embodiments of the robot 100 do not necessarily include a head 112 distinct from the torso 110. Other embodiments of the robot 100 may include a single arm 114 or more than two arms 114.

The mobile base 102 comprises a ground-based support platform for the robot 100. The mobile base 102 may include a set of wheels 104 (e.g., three wheels, four wheels, or more) and a drive system that drives the wheels based on locomotion commands. The wheels 104 may comprise a set of omnidirectional wheels (e.g., Mecanum wheels) a set of steerable wheels, or a combination of steerable and non-steerable wheels. In one implementation, the mobile base 102 may include a passive suspension system to enhance stability and traction when traversing uneven or non-level terrain.

The mobile base 102 may furthermore support a battery and associated power electronics for supplying power to the robot 100. For example, the mobile base 102 may include a quick-release battery connector to enable rapid swapping of batteries for recharging. Additionally, the mobile base 102 may house all or some elements of the control system of the robot 100 such as one or more system-level controllers and associated electronics.

The mobile base 102 may generally be constructed to provide a low center of gravity and a broad support footprint for the robot 100 to support stability over a wide range of ground surfaces and during performance of various tasks. A significant portion of the mass of the robot 100 may reside in the mobile base 102 to provide further stability.

The upper body 120 may include a torso 110, a head 112, and/or one or more robot arms 114.

In some implementations, the upper body 120 may house at least some control processing electronics that operate to control joint actuators of the arms 114 and base joint 106, control the drive system of the mobile base 102, control various output devices of the robot 100 such as speakers or visual indicators, process inputs of the robot 100 from control elements such as a keypad, a touchscreen, a button, a dial, etc., control wired or wireless communications of the robot 100 (e.g., via a network connection), or perform other command and control functions. In one such implementation, the mobile base 102 may house the main system level control and power electronics, while the upper body 120 may include distributed module-level control elements associated with the distributed actuators and sensors.

In some implementations, the upper body 120 of the robot 100 includes a distinct torso 110 and head 112. In such an implementation, the head 112 may be coupled to the torso 110 via an actuated neck joint that may enable rotation of the head 112 relative to the torso 110 (e.g., for various sensing and perception applications). In other implementations, the robot 100 may include an integrated upper body 120 that does not necessarily include a head 112 distinct from the torso 110.

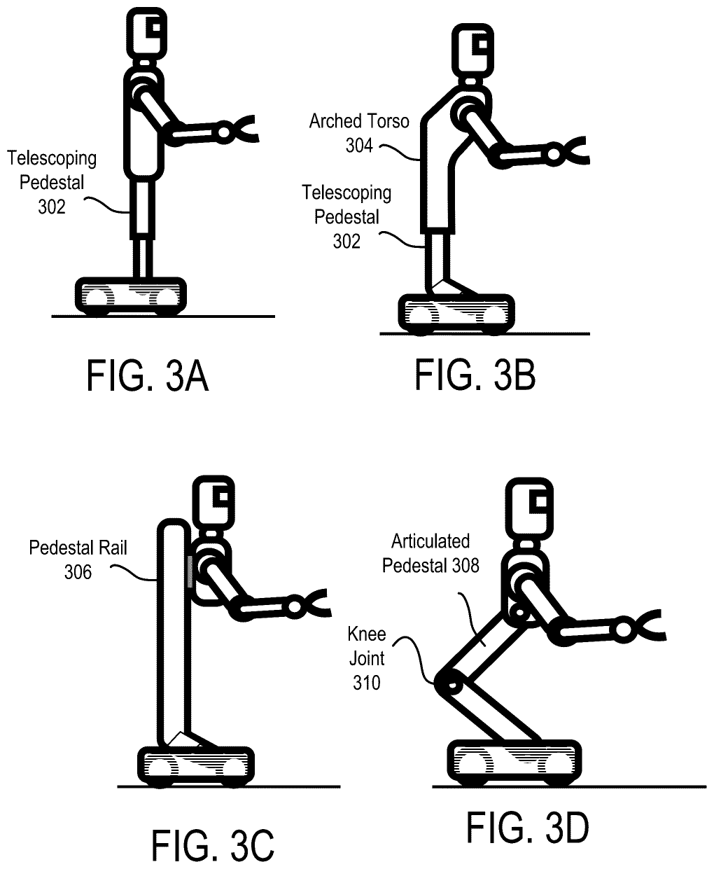

The pedestal 108 extends from the mobile base 102 and supports the torso 110. The pedestal 108 may include a lift mechanism that enables height-adjustability of the torso 110. For example, the pedestal 108 may comprise a telescoping mechanism, a rail system, an articulated joint, or other configuration to enable height adjustments of the torso 110 as will be described in further detail below with respect to FIGS. 3A-D. Height changes may be desirable to support different tasks of the robot 100. For example, in some applications a higher torso height may be desirable to enable the robot 100 to reach shelves or other elevated locations, to provide increased visibility of the environment, to avoid ground-level objects, or support other applications. In other applications a lower torso height may be desirable to decrease the center of gravity and provide increased stability (e.g., when the robot 100 is moving at high speeds and/or accelerating, traversing uneven ground, navigating sharp turns, carrying or pushing heavy objects, etc.). A lower torso height may also be desirable to enable interaction with objects closer to the ground.

The pedestal 108 may be coupled to the mobile base 102 via a base joint 106. In one implementation, the base joint 106 may comprise a two-axis actuator that enables rotation of the pedestal 108 in pitch and roll (but not in yaw) relative to an attachment point on the mobile base 102. Thus, the robot 100 can tilt side to side and/or front to back about axes of rotation of the base joint 106. The base joint 106 may furthermore include a failsafe brake to mechanically lock the orientation of the base joint 106 at a balanced and stable position when the robot 100 is powered off and/or in response to a brake command. For example, a failsafe brake may include a brake actuator that actively disengages the brake when powered, and engages the brake (via a passive mechanism like a spring) when the brake actuator power is lost. The stable position may depend on the state of the robot 100 when the brake is engaged. For example, when the robot is stationary and is not carrying or applying force to an object, the stable position may be an upright position in which the pedestal 108 is substantially vertical. However, if the robot 100 is carrying a heavy object, pushing an object, pulling an object, or otherwise engaged in a manner that changes the center of gravity, the stable position may instead involve the pedestal 108 being tilted in roll and/or pitch for stability.

The robot 100 may include one or more (e.g., two) robot arms 114. The arms 114 may comprise multiple joints to enable multiple degrees of freedom allowing for a wide range of articulated motion suitable for tasks requiring complex positioning and orientation. For example, in one implementation, the arms 114 each include a shoulder joint, an elbow joint, and a wrist joint, that may each have one or more degrees of freedom. In one embodiment, the robot arm comprises seven degrees of freedom (7-DOF) including a 3-DOF shoulder joint, a single DOF elbow joint, and a 3-DOF wrist joint. In another embodiment, the robot arm 114 may comprise five degrees of freedom, six degrees of freedom, or more.

Each robot arm 114 may include an end effector flange 118 for detachably coupling to an end effector 116. The end effector 116 may comprise a tool for interacting with an object or the environment to perform a particular task. Examples of end effectors 116 may include grippers, suction cups, cutting tool, welding tools, sensors, or other instruments. End effectors 116 may incorporate mechanical, electrical, pneumatic, or other control components to enable precise movement and functionality. The end effector flange 118 may be interoperable with different types of end effectors 116 that may be swapped in or out depending on the desired application. In one implementation, the end effector flange 118 and end effector 116 may comprise reciprocal quick attach mechanisms to enable rapid swapping of end effectors 116 suitable for different applications.

The mobile base 102, torso 110, head 112, and/or robot arms 114 may include one or more cameras such as visible light cameras, infrared cameras, LiDAR cameras, or other imaging devices. Camera may comprise individual cameras, stereoscopic cameras, or multiview cameras. Some types of cameras may include illumination elements and/or dedicated depth sensors. Cameras may also include pan and/or tilt mechanisms. The mobile base 102, torso, 110, head 112, and/or robot arms 114 may furthermore integrate other sensors such as inertial sensors (IMUs, accelerometer, gyroscope, magnetometer, etc.), temperature sensors, pressure sensors, noise sensors, tactile sensors, or other sensors that support operation of the robot 100.

The robot 100 may be generally proportioned to have a human-like volume envelope (e.g., relatively tall and narrow) and may therefore be well-suited to perform many tasks traditionally performed by humans. The wide base of the mobile base 102 enables high stability and ground traction while enabling a wide variety of applications.

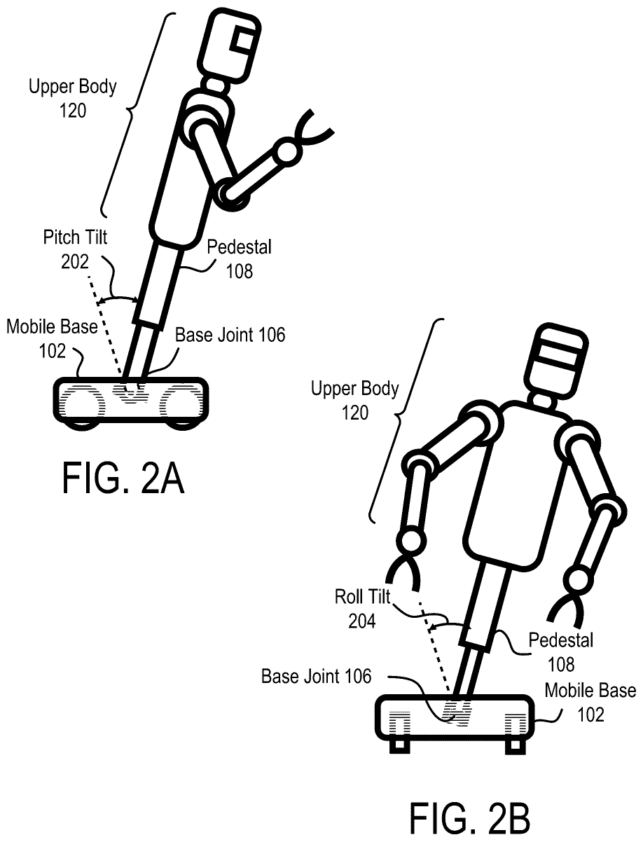

FIGS. 2A-2B illustrate example operations of the base joint 106 when configured as a two-axis actuator. The base joint 106 enables rotation of the pedestal 108 (and connected upper body 120) in pitch 202 (i.e., front-to-back or back-to-front) and/or roll 204 (i.e., side-to-side) about an attachment point to the mobile base 102. Rotations of the base joint 106 may be useful for several reasons. First, angular position of the pedestal 108 may be modified to adjust the center of gravity of the robot 100 and maintain stability in situations such as navigating non-level ground, maneuvering around corners, handling changes in acceleration, or when forces are applied to the robot. Second, angular position of the pedestal 108 may be modified to increase reach of the robot arms 114 and/or sensors in the upper body 120. For example, the robot 100 may tilt to gain visibility around corners, to view or reach around objects, etc. Third, angular position of the pedestal 108 may be modified to avoid collisions with objects. Examples of these scenarios are further described below.

FIGS. 3A-3D illustrate various embodiments of a robot 100 with a height-adjustable upper body 120. In the embodiment of FIG. 3A, the robot 100 includes a telescoping pedestal 302 that can expand or contract in length via a lift actuator. In one implementation, the telescoping pedestal 302 may include one or more nested cylindrical or polygonal tubes in which each progressively higher segment is slightly smaller in diameter than the one below it. Alternatively, each progressively higher segment may be slightly wider in diameter than the one below it. The segments can be extended or retracted into a nested structure along the longitudinal axis of the telescoping pedestal 302 to adjust its overall length. The telescoping pedestal 302 may include various actuated drive components such as screw drives, pneumatic cylinders, hydraulic pistons, electric linear actuators, cable-based systems, or other actuation mechanisms (which may be housed internally to the telescoping pedestal 302) to control relative movement of the respective segments. The telescoping pedestal 302 furthermore includes one or more braking and/or locking mechanisms (electronic and/or mechanical) to secure the telescoping pedestal 302 at a stable height while the pedestal actuators are idle. For example, the telescoping pedestal 302 may include a counterbalance spring to support the weight of the upper body 120 when the actuator lift is idle.

FIG. 3B illustrates an alternative embodiment of a robot 100 with a telescoping pedestal. In this embodiment, the upper body 210 of the robot 100 includes an arched torso 304 that arches towards the front of the robot 100. The telescoping pedestal 302 may attach to the mobile base 102 at a more rearward position relative to the position of the telescoping pedestal 302 in FIG. 3A. This embodiment causes the center of gravity of the arched torso 304 to be offset from the telescoping pedestal 302, which may be useful to enable additional forward lean and greater forward reach (e.g., for reaching to the far side of a shipping pallet to pick up or to place objects on the pallet without navigating around it).

In the embodiment of FIG. 3C, a rail-based pedestal 306 couples the upper body 120 via a rail system. For example, the torso 110 may include an attached carriage that mates with one or more rails of the pedestal 306. The rails may comprise a rigid guide having grooves, slots, or other tracks to constrain motion of a carriage along a single vertical axis. The carriage and attached torso 110 may be driven along the rail by a linear actuator such as a lead screw, belt drive, cable system, or other actuator mechanism. The rail-based pedestal 306 may furthermore include a braking elements and/or mechanical locks to secure the upper body 120 at a configured position along the rail.

In the embodiment of FIG. 3D, an articulated pedestal 308 includes one or more actuated joints 310 that couple two or more pedestal segments between the mobile base 102 and the upper body 120. For example, the pedestal 108 may include a first segment coupled between the base joint 106 of the mobile base 102 and a knee joint 310, and a second segment coupled between the knee joint 310 and the upper body 120. The knee joint 310 may be actuated in coordinate with the base joint 106 to raise or lower the upper body 120 at a variety of heights and pitch angles.

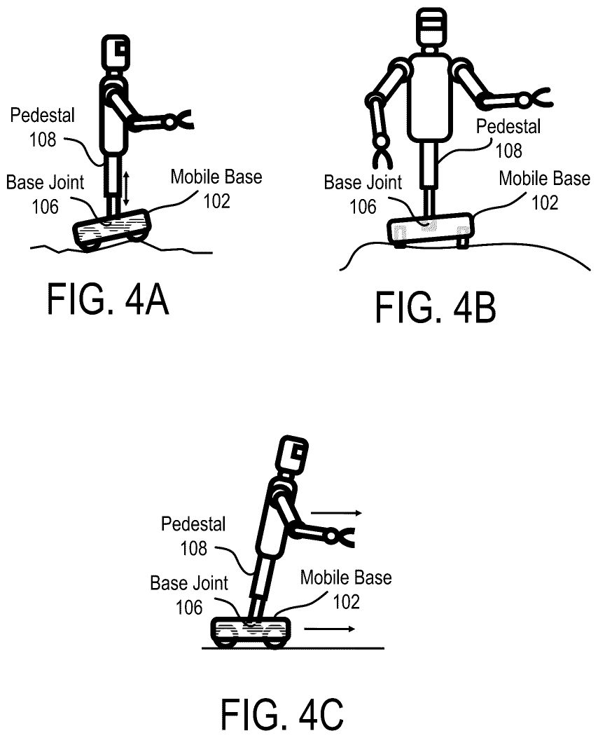

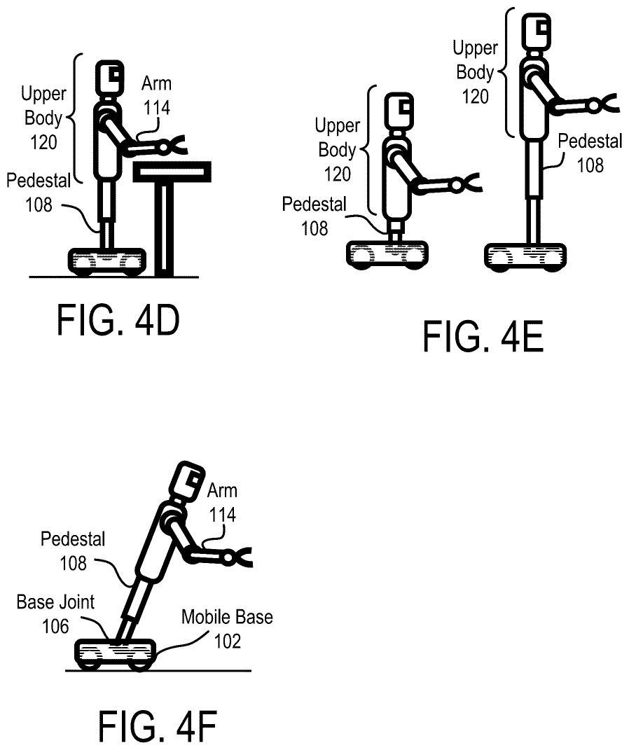

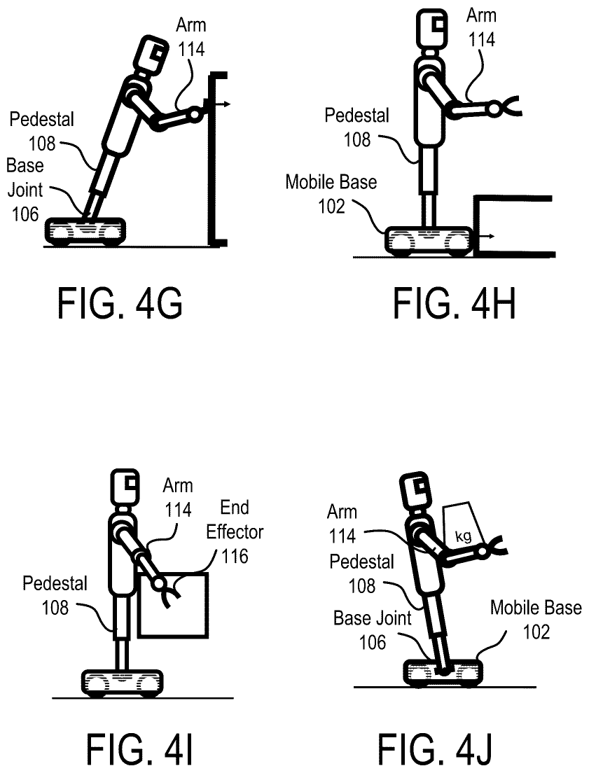

FIGS. 4A-4J illustrates examples of different types of tasks that can be carried by the robot 100 enabled in part by control of the base joint 106 in coordination with the drive system of the mobile base 102, movement of the robot arms 114, operation of the pedestal lift, or other control elements. In FIG. 4A, the robot 100 is shown navigating over uneven ground while maintaining balance. Here, the base joint 106 may be controlled to pivot the pedestal 108 relative to the mobile base 102 so as to maintain stability and minimize vibration of the upper body 120. The stability condition may be defined as a condition that avoids the robot 100 falling over. For example, the base joint 106 may maintain an angular position such that a torque about the base joint 106 is zero or substantially zero. When the robot 100 is not moving, this condition occurs when the center of gravity of the pedestal 108 and upper body 120 lies directly above the base joint 106. In a configuration where the center of gravity of the upper body 120 is along the same axis as the longitudinal extent of the pedestal 108, the robot 100 may operate to maintain the pedestal 108 at a vertical orientation regardless of the pitch and roll of the mobile base 102 (which may conform to the ground surface angles). In the example, FIG. 4A, when the robot 100 is traversing uphill, the robot 100 may maintain an acute forward pitch angle between the mobile base 102 and the pedestal 108 to maintain verticality of the pedestal 108. When the robot 100 is traversing downhill, the robot 100 may maintain an obtuse forward pitch angle between the mobile base 102 and the pedestal 108 to maintain verticality of the pedestal 108. The mobile base 102 may furthermore include a suspension system to enable the mobile base 102 to maintain contact between the ground and all wheels.

As illustrated in FIG. 4B, the robot 100 may similarly control side-to-side tilt of the pedestal 108 to maintain stability on uneven surfaces. For example, the robot 100 may tilt the pedestal 108 relative to the mobile base 102 to compensate for ground that slopes side-to-side in order to maintain a vertical orientation of the pedestal 108.

FIG. 4C illustrates an example embodiment of a robot 100 while accelerating forward. Here, the robot 100 may tilt the pedestal 108 forward about the base joint 106 to move the center of gravity forward and counteract torque on the mobile base 102 caused by the acceleration of the robot 100. The robot 100 may therefore achieve high stability during such motion. Furthermore, the robot 100 may tilt backwards when braking or otherwise decelerating. The robot 100 may similarly tilt side-to-side when navigating around turns so as to lean into the turns to achieve high traction and stability. For example, the level of tilt may be controlled to maximize stability.

FIG. 4D-F illustrates various benefits of the overall form factor of the robot 100 and the height-adjustable upper body 120 enabled by the lift mechanism of the pedestal 108. FIG. 4D shows that the height of the upper body 120 can be adjusted via the pedestal 108 to enable positioning of the robot arms 114 (and/or sensors in the upper body 120) at an appropriate height for performing a particular task. For example, the robot arms 114 may be adjusted to a height suitable for manipulating objects on a table, shelf, or other raised platform.

As shown in FIG. 4E, the robot 100 may control height of the upper body 120 (by actuating a telescoping mechanism or other length-adjusting mechanism of the pedestal 108) for a particular task. For example, the upper body 120 may be lowered to allow the robot 100 to interact with objects or deploy sensors at relatively lower heights, or the upper body 120 may be raised to allow the robot 100 to interact with objects or deploy sensors at relatively higher heights.

FIG. 4F shows an example in which various aspects of the robot 100 may be controlled to adjust its reach for a variety of applications such as interacting hard-to-reach objects, positioning sensors, etc. For example, to achieve the maximize reach, the robot 100 may employ a combination of techniques including extending its arms 114, extending the pedestal 108, and/or tilting the robot about the base joint 106 in the direction of reach. Since much of the mass of the robot 100 may reside in the mobile base 102, the robot 100 can achieve significant reach while maintaining stability.

FIGS. 4G-H illustrate examples in which the robot 100 may push or pull objects. In FIG. 4G, the robot 100 operates to push an object using its arms 114. In this example, the base joint 106 may be manipulated to tilt the robot 100 in the direction of the object, and thereby increase the force applied to the object while maintaining stability of the robot 100. In FIG. 4H, the robot 100 operates to push an object using the mobile base 102, which is useful for shorter objects that may be out of reach of the robot arms 114. Here, the base joint 106 may maintain the pedestal 108 in a substantially upright position to maintain stability.

FIGS. 4I-J illustrate examples in which the robot 100 carries objects. In FIG. 4I, the robot 100 may grasp the object using its arms 114 (e.g., using gripper-type end effectors 116) while holding the object with the arms 114 substantially extended downward. This position enables the robot 100 and object to have a relatively low center of gravity for improved stability relative to objects carried at higher positions. In FIG. 4J, the robot 100 carries a heavy load using its arms 114 in a substantially horizontal or curled position, thus positioning the object higher up relative to the position in FIG. 4I. The robot 100 may compensate for the more forward center of gravity by tilting the pedestal rearward via the base joint 106, such that a stability condition (e.g., substantially zero torque about the base joint 106) is maintained.

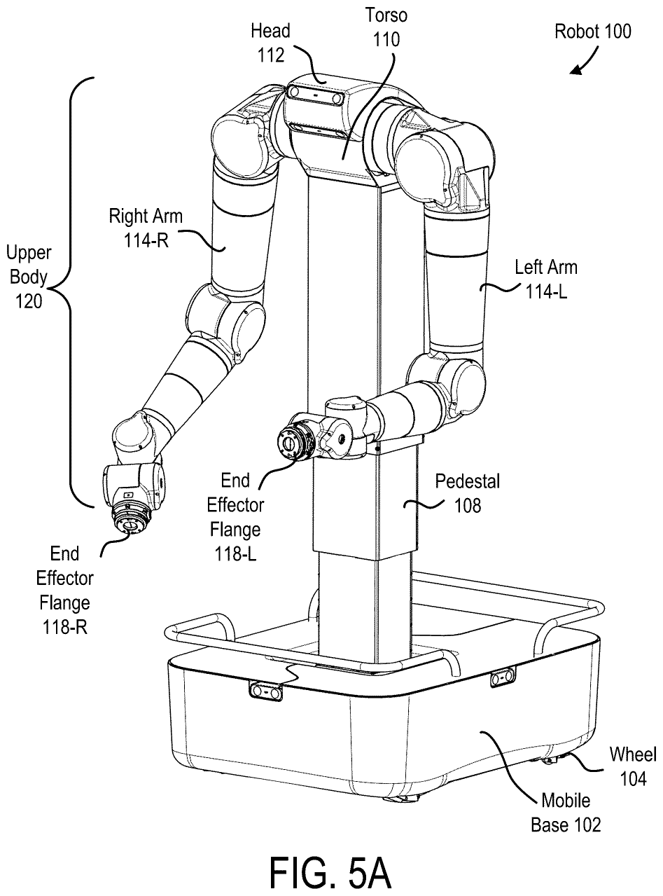

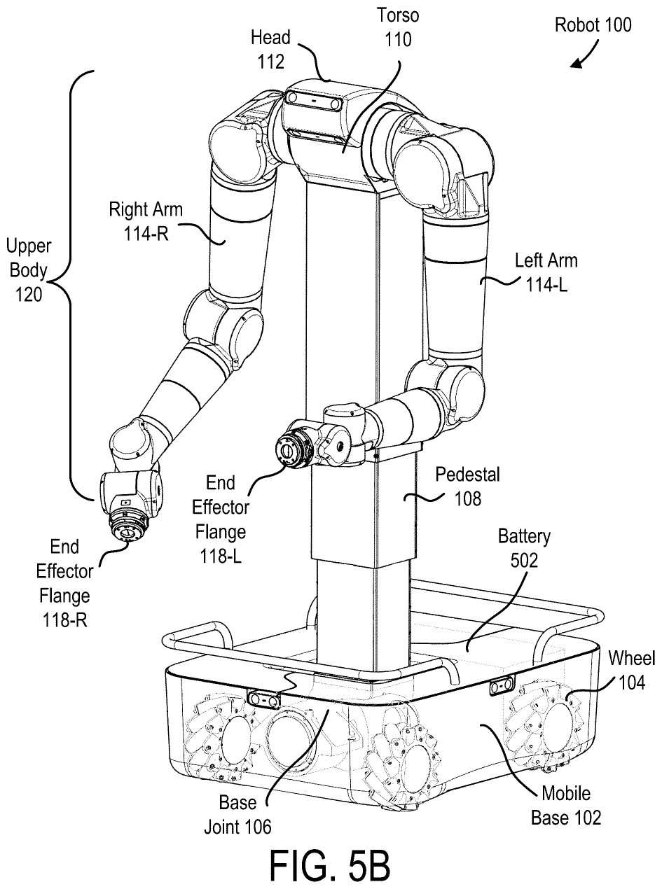

FIG. 5A illustrates an example implementation of a robot 100. FIG. 5B shows the same implementation of the robot 100 with the view including partial transparency in the housing of the mobile base 102 for the purpose of illustrating the internal components. In this example, the robot 100 includes a mobile base 102 with omnidirectional Mecanum wheels 104, a pedestal 108 with a telescoping configuration coupled to the mobile base 102 via a base joint 106, and an upper body 120 with a torso 110 coupled to a pair of 7-DOF robot arms 114 (e.g., a right arm 114-R with right end effector flange 118-R and a left arm 114-L with left end effector flange 118-L), and a head 112. A battery 502 may be housed within the mobile base 102 to supply power to the robot 100.

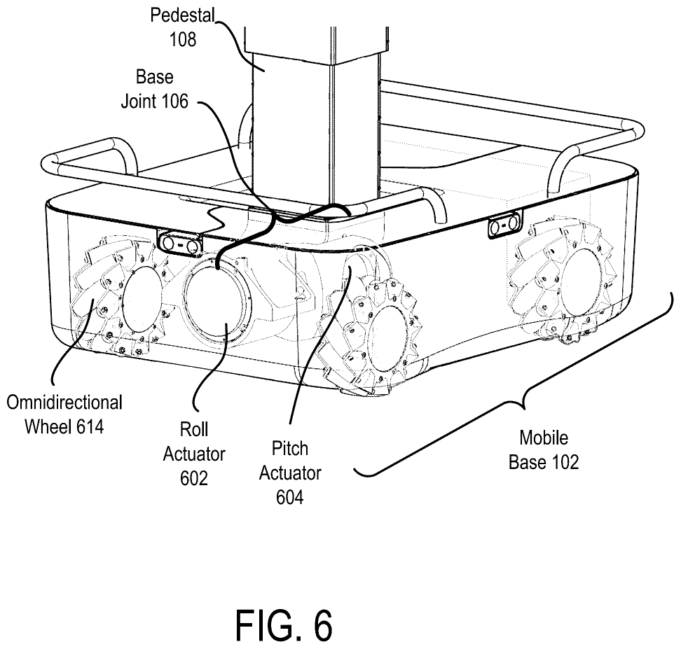

FIG. 6 further illustrates an example implementation of the mobile base 102 and the base joint 106. In this example, the base joint 106 includes a roll actuator 602 coupled to the mobile base 102 and a series connected pitch actuator 604 coupled between the roll actuator 602 and the pedestal 108. Actuation of the roll actuator 602 causes change in roll (side-to-side tilt) of the connected pitch actuator 604 and pedestal 108. Actuation of the pitch actuator 604 causes change in pitch (front-to-rear or rear-to-front tilt) of the connected pedestal 108. Actuation of the roll actuator 602 and pitch actuator 604 may occur concurrently to achieve a wide range of pedestal angles in pitch and roll.

In alternative embodiments, the roll actuator 602 and pitch actuator 604 may be coupled in opposite order. For example, the pitch actuator 604 may be coupled directly to the mobile base 102 and the roll actuator 602 may be coupled between the pitch actuator 604 and the pedestal 108. In other embodiments, a single two-axis actuator may be used that does not necessarily employ series rotary actuators 602, 604. For example, two rotary or linear actuators may be used in a parallel configuration to position the pedestal in pitch and roll.

The actuators 602, 604 may include braking mechanisms to decelerate rotation of the joints and/or locking mechanisms to secure the respective joints at a given position. In an embodiment, a failsafe mechanism may be used to lock the actuators 602, 604 at a balanced position when the robot 100 loses power or when the actuators 602, 604 are otherwise idle.

The omnidirectional (e.g., Mecanum) wheels 614 shown in FIG. 6 may offer enhanced mobility of the robot 100 by enabling the robot 100 to move forward, backward, sideways, diagonally, or rotate in place without changing its orientation. By precisely controlling the speed and direction of each individual wheel 614, the robot 100 may perform agile maneuvers in constrained environments, such as warehouse aisles or factory floors.

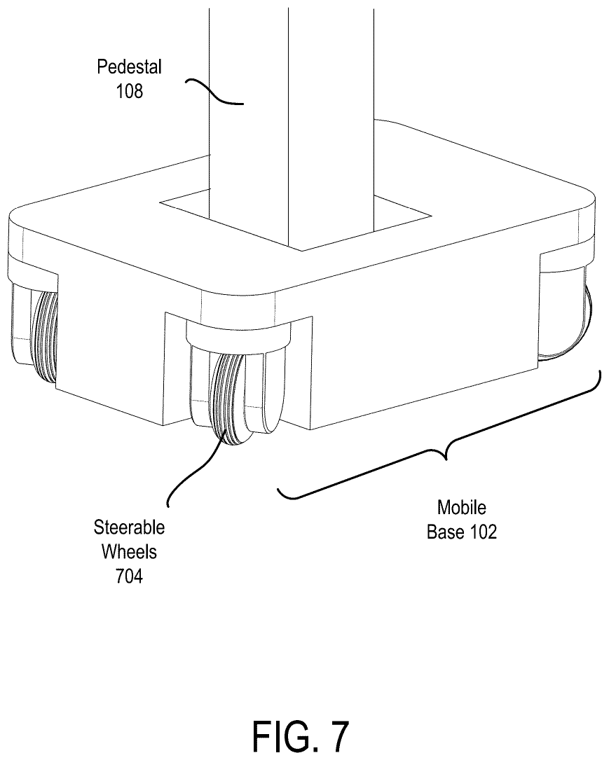

FIG. 7 illustrates an alternative embodiment of a mobile base 102 for a robot 100. In this example, the mobile base 102 includes four steerable wheels 704. Each wheel 704 may be independently steered for enhanced maneuverability, stability, and control, especially in tight or complex environments. For example, by coordinating steering of each wheel 704, the mobile base 102 can achieve a tight turning radius (e.g., a turning radius of zero), allowing it to navigate confined spaces more easily than traditional front-steering systems. This configuration may also provide enhanced handling at various speeds and accelerations. For example, controlling turning of the rear wheels 704 in the opposite direction of the front wheels 704 at low speeds may increase agility, while turning all wheels 704 in the same direction at high speeds may enhance stability around turns.

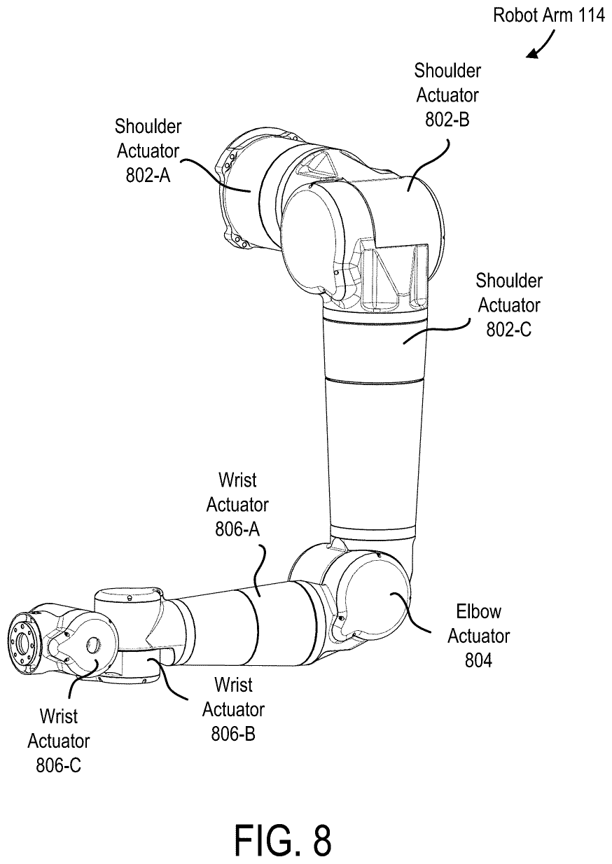

FIG. 8 illustrates an example internal view of a robot arm 114. The robot arm 114 includes a one or more shoulder joint actuators 802 (e.g., a first shoulder joint actuator 802-A, a second shoulder joint actuator 802-B, and a third should joint actuator 802-C to enable a 3-DOF shoulder), one or more elbow joint actuators 804 (e.g., a single elbow joint actuator 804 in this example), and one or more wrist joint actuators (e.g., a first wrist joint actuator 806-A, a second wrist joint actuator 806-B, and a third wrist joint actuator 806-C to enable a 3-DOF wrist). Each of the actuators 802, 804, 806 may comprise independently controllable rotary motors that may be controlled in coordination to achieve a position and/or motion objective. In an embodiment, the actuators 802, 804, 806 may comprise high torque-density motors, strain-wave (e.g., harmonic drive) gearing, dual encoders, and internal drive electronics. Each of the joints may furthermore include integrated sensors (e.g., torque sensors) to provide control feedback to a controller as will be described in further detail below. The actuators 802, 804, 806 may furthermore comprise braking and/or locking mechanisms to maintain the arm 114 at a stable position when the actuators 802, 804, 806 are idle.

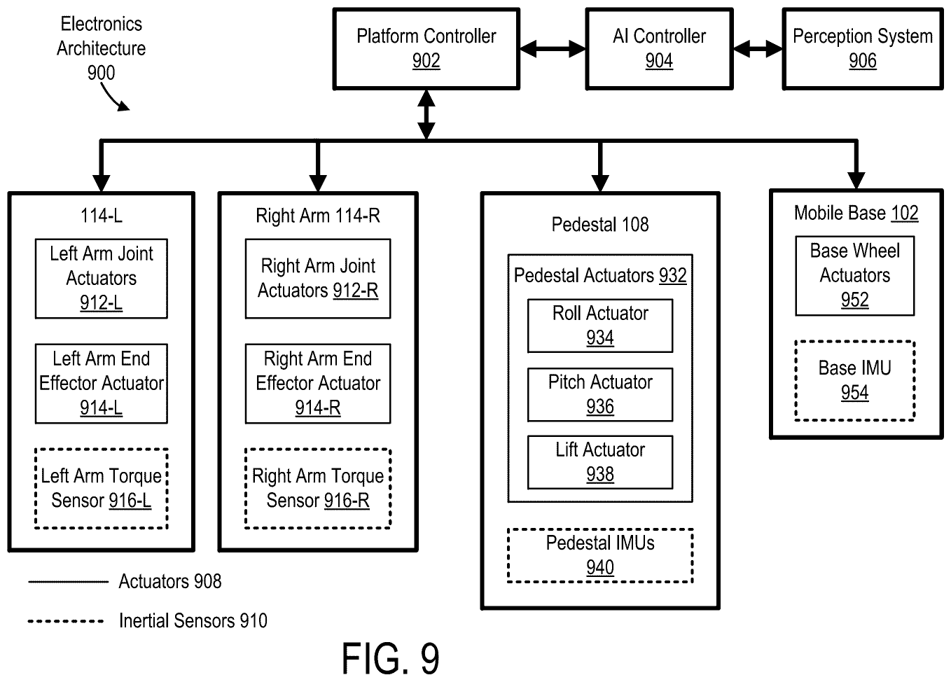

FIG. 9 illustrates an example embodiment of an electronics architecture 900 for a robot 100. The electronics architecture includes a platform controller 902, an artificial intelligence (AI) controller 904, a perception system 906, a set of actuators 908, and a set of inertial sensors 910. The actuators 908 may include a set of left arm actuators 912-L (e.g., seven actuators associated with a 7-DOF robot arm 114-L) a left arm end effector actuator 914-L, a set of right arm actuators 912-R (e.g., seven actuators associated with a 7-DOF robot arm 114-R) a right arm end effector actuator 914-R, a set of pedestal actuators 932 (including a pedestal roll actuator 934, a pedestal pitch actuator 936, and a pedestal lift actuator 938), and a set of base wheel actuators 952. The arm joint actuators 912 and pedestal pitch and roll actuators 934, 936 may comprise, for example, high torque-density motors, strain-wave (e.g., harmonic drive) gearing, dual encoders, and internal drive electronics. The lift actuator 938 may be implemented using a pulley and cable mechanism together with a servo motor and ballscrew linear actuator internal to the pedestal 108. Gas springs may be used to offset static load. The inertial sensors 910 may include left arm torque sensors 916-L, right arm torque sensors 916-R, one or more pedestal IMUs 940, and one or more base IMUs 954.

The perception system 906 may comprise a set of cameras and/or other sensors for perceiving an environment of the robot 100. For example, in one embodiment, the perception system 906 may include one or more forward facing cameras, one or more rear facing cameras, one or more upward facing cameras, one or more downward facing cameras, one or more left facing cameras, and one or more right facing cameras. These cameras may comprise standard cameras, stereoscopic cameras, or multi-view cameras that enable depth perception. In some implementations, the cameras may include illumination systems and/or depth sensing cameras. Cameras may furthermore include actuated pan and/or tilt mechanisms. For example, in one implementation, at least one left facing, right facing, forward facing, and rear facing cameras are integrated into the mobile base 102, and at least an upward facing and downward facing camera are integrated into the head 112 or torso 110. In other embodiments, cameras may be integrated into the pedestal 108 or elsewhere on the robot 100. In an embodiment, the robot 100 may also include cameras on each robot arm 114 (e.g., located near a wrist of the robot arm 114) that may be precisely maneuvered by the robot 100 through control of the robot arm 114. In further embodiments, the perception system 906 may include other types of sensors such as internal sensors, proximity sensors, temperatures sensors, LiDAR sensors, pressure sensors, or other sensors.

The AI controller 904 may obtain sensor data from the perception system 906 and process the sensor data to perform various processing tasks such as identifying objects, recognizing patterns in the environment, determining spatial layouts of areas, etc. The AI controller 904 may utilize various image processing algorithms and/or machine learning models trained to perform tasks such as object detection and/or recognition based on visual data and/or other sensor data captured by the perception system 906. These models may comprise edge-deployed models that execute locally on the robot 100 (e.g., using one or more specialized neural processing units (NPUs)), or may be executed in a cloud environment via a network connection of the AI controller 904. The AI controller 904 may furthermore implement functions such as high-level behavior planning and motion planning based on perception data inputs.

The platform controller 902 generates motion commands to implement motion control of the robot 100 by controlling the various actuators 908 to perform various tasks based on input control signals, sensed environmental signals from the AI controller 904, and feedback from the inertial sensors 910. For example, in each robot arm 114, the joint actuators 912 and torque sensors 916 work together with the platform controller 902 to precisely manage movement of the arms 114. In operation, the actuators 912 generate torques for the respective joints to control the arms 114 to achieve a desired position and/or motion path. The torque sensors 916 measure the rotational forces applied at each joint (with respective to one or more axes of rotation), and provide real-time feedback to the platform controller 902 to indicate how much force is being exerted or resisted. The platform controller 902 may then adjust the arm joint actuators 912 accordingly to achieve smooth, accurate, and responsive motion. This closed-loop feedback system ensures that the robot arm moves as intended while adapting to dynamic conditions or external disturbances.

The left and right arm end effector actuators 914 may be controlled by the platform controller 902 to perform certain tasks such as grabbing, activating an instrument (such as cutting instrument, welding instrument, or other tool), or other tasks associated with the end effectors. The platform controller 902 may coordinate activation of the end effector actuators 914 with sensor measurements and control signals from the AI controller 904 (which may be based on sensed environment from the perception system 906) to achieve a desired task such as picking up an object, moving an object, or otherwise interacting with the environment.

The pedestal IMUs 940 may similarly generate feedback relating to motion and forces of the pedestal actuators 932. The platform controller 902 may combine this sensor feedback with motion control inputs to achieve desired motion and position of pedestal actuators 932 (e.g., achieving certain tilt angles and/or lift position). One aspect of this control mechanism may relate to maintaining balance of the robot 100. For example, the platform controller 902 may sense stability conditions of the robot 100 such as torque at the base joint 106, and control the pedestal actuators 932 in a manner that reduces magnitude of the torque towards zero. In other instances, the pedestal actuators 932 may be controlled to avoid collisions with detected objects. The platform controller 902 may furthermore control the actuators 932 to achieve certain tasks of the robot, which may involve tilting the robot 100 and/or extending or detracting the pedestal 108 in association with reaching objects, lifting objects, carrying objects, avoiding objects, navigating through a motion path, or other tasks.

The platform controller 902 may furthermore control the mobile base 102 to perform locomotion of the robot 100 according to a planned motion path, to reach a desired position, to avoid collisions, or to achieve other navigation objectives. For example, the platform controller 902 may obtain inertial sensor data from the base IMU 954 and control the wheel actuators 952 to achieve specified navigation of the robot 100.

The platform controller 902 may furthermore coordinate control between the different sets of actuators 908 in the arms 114, pedestal 108, and mobile base 102 to achieve control objectives. For example, the platform controller 902 may cause the robot 100 to tilt forward (via the pitch actuator 936) while accelerating (via the base wheel actuators 942) in order to achieve improved traction and stability. In another example, the robot 100 may coordinate lift and/or tilt of the pedestal 108 together with motion the arms 114 to achieve objectives such as lifting objects, placing objects, etc.

In one implementation, the platform controller 902 may be coupled to the AI controller 904 via an Ethernet connection, and may communicate with the respective actuators 908 and sensors via an EtherCat protocol. The AI controller 904 and perception system 906 may communicate via a gigabit multimedia serial link (GMSL) or other high speed video communication protocol. The platform controller 902 and AI controller 904 may each be implemented using one or more processors that execute instructions stored to a non-transitory computer readable storage medium. The one or more processors may include one or more general purpose processors (CPUs), one or more graphics processing units (GPUs), one or more neural processing units (NPUs), or other special-purpose processors. In alternative embodiments, the platform controller 902 and/or AI controller 904 may include cloud connectivity via a wireless communication module. In this implementation, at least some of the functions attributed to the platform controller 902 and/or AI controller 904 may be performed remotely in a cloud computing environment.

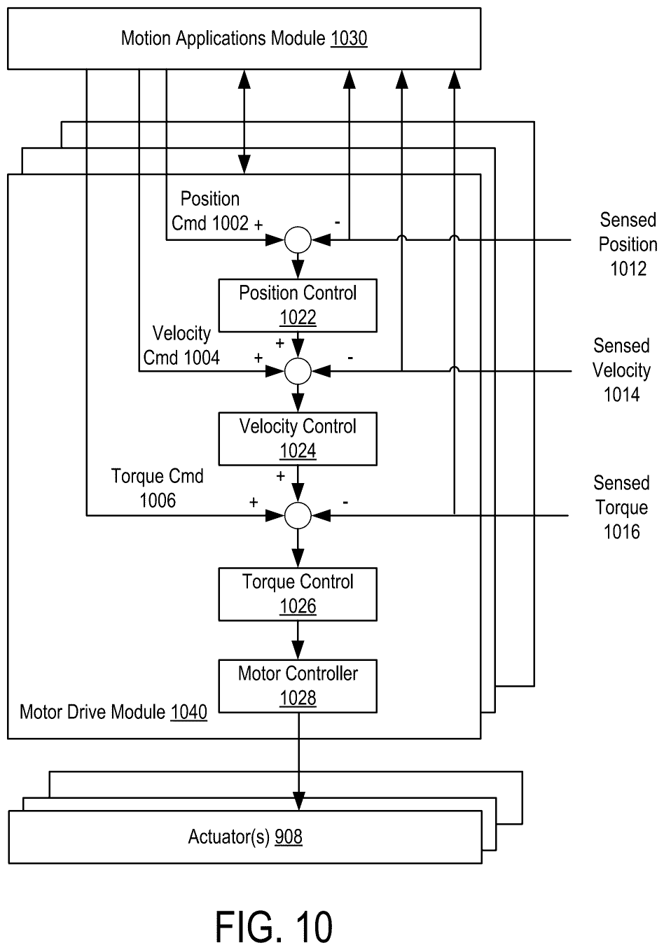

FIG. 10 illustrates an example embodiment of a control process that may be implemented by the electronics architecture 900 of the robot 100. In an example implementation, the control process is implemented in a plurality of motor drive modules 1040 (e.g., one module 1040 per actuator 908). The motor drive modules 1040 may be distributed such that they positioned adjacent to respective actuators 908. In alternative embodiments, motor drive modules 1040 may be integrated into a centralized controller (e.g., the platform controller 902 or separate drive controller in the mobile base 102, torso, 110, or other location). A motion applications module 1030 executes one or more motion applications to determine motion commands 1002, 1004, 1006 associated with various actuators 908. Here, the motion applications module 1030 may be implemented as executable code within the platform controller 902, the AI controller 904, a separate application controller (not shown) or a combination thereof. The motion commands 1002, 1004, 1006 may be provided to the respective motor drive modules 1040 that directly control the actuators 908. For example, for each actuator 908, the motion applications module 1030 generates position command 1002, velocity commands 1004, and/or torque commands 1006 relating to a motion objective. In the motor drive module 1040, the position command 1002 is combined with the sensed position 1012 of the actuator 908 (from a corresponding inertial sensor 910) in a negative feedback loop to generate a position control objective 1022. The position control objective 1022 is then combined with a velocity command 1004 and the sensed velocity 1014 (in a negative feedback loop) from a corresponding inertial sensor 910 to generate a velocity control objective 1024. The velocity control objective 1014 is combined with a torque command 1006, and combined with the sensed torque 1016 from a corresponding inertial sensor 910 in a negative feedback look to generate a torque control objective 1026. The torque control objective 1026 is input to a motor controller 1028 that directly controls motors of the actuators 908. For example, in one embodiment, the motor controller 1028 comprises a field-oriented control (FOC) motor controller that converts the torque control objective 1026 into modulated motor currents (e.g., using pulse width modulation or other control signal).

The above-described control algorithm may be implemented for each of the actuators 908 to enable concurrent and coordinated control of the robot 100. The position, velocity, and/or torque commands 1002, 1004, 1006 for each actuator 908 may be generated in association with one or more motion applications of the motion applications module 1030 that generates these commands 1002, 1004, 1006 in accordance with a specific objective. Examples of motion applications of the motion applications module 1030 may include: an active suspension application that seeks to reject ground disturbances via actuation of the lift actuator; an admittance control application that enables hand guidance of the robot via admittance control; a dynamics compensation application that employs model-based torque calculation to compensate for inertia, Coriolis effect, and/or external forces; a gravity compensation application that operates to perform a model-based torque calculation to compensate for gravity effects; a joint calibration application to perform a calibration routine that obtains offsets for initially zeroing joint inertial parameters, and performing non-linear kinematics compensation during motion of the robot 100; a base motion control application to perform planning and control of the mobile base navigation; a balance control application to perform dynamic balancing of the robot via the pedestal actuators 932; an impedance control application to perform impedance control of the robot arms within a task space; a twist control application to perform twist velocity control of the robot arms 114 in the joint and task space; a point-to-point motion planning application to implement point-ot-point trajectory execution of the upper body 120 and/or arms 114; and/or a teleoperation application that enables control of individual or a collection of actuators 908 via an input device (e.g., a gamepad, mouse, keyboard, joystick, motion capture controller, touchscreen, trackpad, or other input device).

The various applications may execute in parallel to generate combined position, velocity, and/or torque commands 1002, 1004, 1006 for concurrently achieving multiple motion objectives associated with different applications. In one implementation, the sensed position, velocity, and torque 1012, 1014, 1016 from the actuators 908 may also be sent to the motion applications module 1030 as feedback signals.

In an example implementation, the motion applications module 1030 and/or components of the motor drive module 1040 may be implemented as non-transitory computer-readable storage medium that stores instructions executable by one or more processors. In one implementation, connectivity between the motion applications module 1030 and the motor drive module 1040 may be achieved via Ethernet cables using an EtherCat protocol. In other implementations, a different wired or wireless communication protocol may be employed.

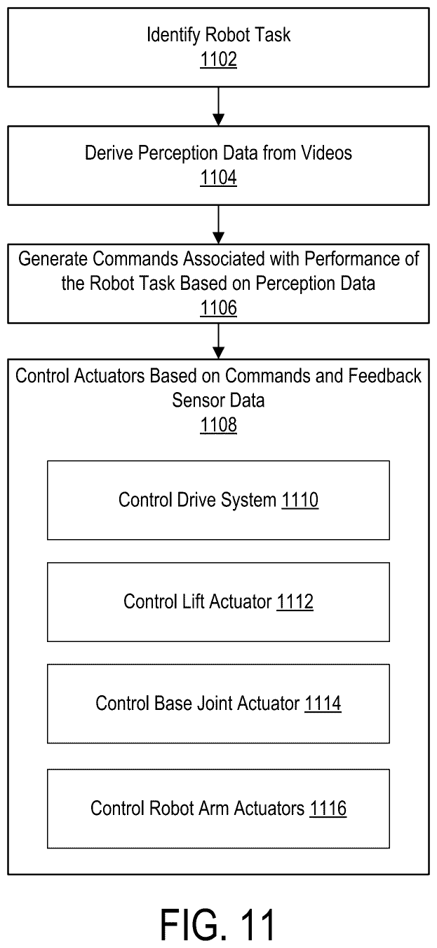

FIG. 11 illustrates an example of a control process for controlling a robot 100. A control system (such as that illustrated in FIGS. 9-10) obtains 1102 a robot task to be performed by the robot 100. The task may include locomotion tasks associated with movement of the robot 100, interacting with objects (e.g., lifting, pushing, moving, etc.), avoiding objects, maneuvering in an environment to sense conditions at certain locations, etc. The control system may obtain a plurality of videos from the perception system 906 (e.g., set of cameras) of the robot 100 and derive 1104 perception data relevant to performance of the robot task. For example, the perception data may relate to recognizing an object, detecting a motion path, detecting a fault condition such as an imminent collision, etc. The control system generates 1106 commands associated with performance of the robot task based on the perception data. The commands may relate to control of position, velocity, and/or torque of the various actuators 908 of the robot 100 to achieve the robot task in coordination with the observed environmental conditions from the perception system 906. Commands may also relate to maintaining stability or achieving other objectives while performing an explicit robot task. The control system controls 1108 the various actuators 908 of the robot 100 in a coordinate manner to achieve the robot task, based in part on feedback from inertial sensors 910 of the various actuators 908. For example, the robot controls 1110 a drive system of a mobile base 102 to enable ground-based locomotion of the mobile base 102 based on sensor signals from the base IMU 954 and commands associated with the robot task. The control system may furthermore control a lift actuator 938 of the pedestal 108 based on sensor signals from pedestal IMUs 940 associated with the lift actuator 938 and the commands associated with the robot task. Furthermore, the control system may control the two-axis base joint 106 to rotate in pitch and roll (via the roll actuator 934 and pitch actuator 936) about respective axes of rotation of the two-axis actuated base joint based on sensor signals from the pedestal IMU 940 and the commands associated with the robot task. The control system may also control motion of the pair of robotic arms 114 via a set of arm joint actuators 912 based on sensor signals from arm torque sensors 916 and the commands associated with the robot task.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These operations, while described functionally, computationally, or logically, are understood to be implemented by computer programs or equivalent electrical circuits, microcode, or the like. The described operations and their associated modules may be embodied in software, firmware, hardware, or any combinations thereof.

Any of the steps, operations, or processes described herein may be performed or implemented with one or more hardware or software modules, alone or in combination with other devices. Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible non-transitory computer readable storage medium or any type of media suitable for storing electronic instructions and coupled to a computer system bus. Furthermore, any computing systems referred to in the specification may include a single processor or may include architectures employing multiple processor designs for increased computing capability.

Finally, the language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention, which is set forth in the following claims.

1. A robot comprising:
a mobile base including a drive system to enable ground-based locomotion of the mobile base;
a pedestal including a lift actuator to support a height-adjustable upper body;
a two-axis actuated base joint coupling the pedestal to the mobile base to enable the pedestal to rotate in pitch and roll about respective axes of rotation of two-axis actuated base joint;
a pair of robotic arms coupled to the height-adjustable upper body, the pair of robotic arms controllable via a set of arm joint actuators to perform a robot task;
a plurality of sensors to obtain sensor signals indicative of a state of the robot; and
a controller to generate, based on the sensor signals and a task objective associated with the robot task, actuator commands for controlling the drive system of the mobile base, the lift actuator of the pedestal, the set of arm joint actuators, and the two-axis actuated base joint.

2. The robot of claim 1, wherein the controller automatically controls at least the two-axis actuated base joint to automatically maintain stability of the robot.

3. The robot of claim 1, wherein the pedestal comprises an actuated telescoping structure to control height of the height-adjustable upper body.

4. The robot of claim 1, wherein the pedestal comprises an actuated rail system to control height of the height-adjustable upper body.

5. The robot of claim 1, wherein the pedestal comprises an articulated joint to control height of the height-adjustable upper body.

6. The robot of claim 1, wherein the drive system includes a set of at least three omnidirectional wheels.

7. The robot of claim 1, wherein the drive system includes a set of at least three steerable wheels.

8. The robot of claim 1, wherein the mobile base includes a replaceable battery to supply power to the robot.

9. The robot of claim 1, wherein the two-axis actuated base joint comprises:
a roll actuator coupled to the mobile base; and
a pitch actuator coupled between the roll actuator and the pedestal.

10. The robot of claim 1, wherein the pair of robot arms each comprise a 7-DOF robot arm.

11. The robot of claim 1 wherein the pair of robot arms each include an end effector flange for coupling to a removable end effector.

12. The robot of claim 1, wherein the robot task includes at least one of: lifting an object, carrying an object, pushing an object, pulling an object, and placing an object.

13. The robot of claim 1, wherein one or more of the plurality of sensors include a set of cameras integrated into the height-adjustable upper body of the robot.

14. The robot of claim 1, wherein the drive system includes a passive suspension system.

15. The robot of claim 1, wherein the two-axis actuated base joint includes a failsafe brake that stabilizes the two-axis actuated base joint at a stable position when the failsafe brake is engaged.

16. The robot of claim 1, wherein the lift actuator includes a failsafe brake that stabilizes the pedestal when the failsafe brake is engaged.

17. A controller system for a robot, comprising:
a camera-based perception system to obtain a plurality of videos from a set of cameras of the robot;
an artificial intelligence controller to derive perception data from the videos in association with performance of a robot task;
a control system including:
a drive control mechanism to control a drive system of a mobile base to enable ground-based locomotion of the mobile base based on sensor signals from the drive system and commands associated with the robot task;
a pedestal lift control mechanism to control a lift actuator of a pedestal that supports a height-adjustable upper body, the pedestal lift control mechanism operating based on sensor signals from the lift actuator and the commands associated with the robot task;
a two-axis actuated base joint control mechanism to control a two-axis actuated base joint coupling the pedestal to the mobile base, wherein the two-axis actuated base joint enables the pedestal to rotate in pitch and roll about respective axes of rotation of two-axis actuated base joint, wherein the two-axis actuated base joint control mechanism operates based on sensor signals from the two-axis actuated base joint and the commands associated with the robot task; and
an arm control mechanism to control motion of a pair of robotic arms via a set of arm joint actuators coupled to the height-adjustable upper body, wherein the arm control mechanism operates based on sensor signals from the arm joint actuators and the commands associated with the robot task.

18. The controller system of claim 17, wherein the control system automatically controls at least the two-axis actuated base joint to automatically maintain stability of the robot.

19. The controller system of claim 17, wherein the pedestal lift control mechanism controls actuation of a telescoping structure of the pedestal that controls height of the height-adjustable upper body.

20. A method for controlling a robot, comprising:
obtaining a robot task to be performed by the robot;
obtaining a plurality of videos from a set of cameras of the robot;
deriving perception data from the plurality of videos in association with performance of the robot task;
generating commands associated with performance of the robot task based on the perception data;
controlling a drive system of a mobile base to enable ground-based locomotion of the mobile base based on sensor signals from the drive system and commands associated with the robot task;
control a lift actuator of a pedestal that supports a height-adjustable upper body, based on sensor signals from the lift actuator and the commands associated with the robot task;
controlling a two-axis actuated base joint coupling the pedestal to the mobile base, wherein the two-axis actuated base joint enables the pedestal to rotate in pitch and roll about respective axes of rotation of two-axis actuated base joint, wherein controlling the two-axis actuated base joint is based on sensor signals from the two-axis actuated base joint and the commands associated with the robot task; and
controlling motion of a pair of robotic arms via a set of arm joint actuators coupled to the height-adjustable upper body based on sensor signals from the arm joint actuators and the commands associated with the robot task.
